(19) United States
(12) Patent Application Publication
(10) Pub. No.: US 2014/0181070 A1
(43) Pub. Date: Jun. 26, 2014

(54) PEOPLE SEARCHES USING IMAGES

(71) Applicant: MICROSOFT CORPORATION, Redmond, WA (US)

(72) Inventor: JUSTIN ORMONT, Mountainview, CA (US)

(73) Assignee: MICROSOFT CORPORATION, Redmond, WA (US)

(21) Appl. No.: 13/723,475

(22) Filed: Dec. 21, 2012

(51) Int. Cl. G06F 17/30

(52) U.S. Cl. CPC G06F 17/30864
USPC 707/709; 707/711; 709/204

(57) ABSTRACT

Methods, systems, and computer-readable media for resolving a search query for a person using an image of the person are provided. An image index containing web images and links to the web images is created. Identifiers of the web images are mapped to the links to the web images and stored in the image index. A search query for a person is received. Upon recognizing the intent of the search query is to find information about the person, at least one digital image related to the person is selected, and an identifier of the digital image is submitted to the image index. The identifier of the digital image is compared against the identifiers of the stored web images and determined to correspond to an identifier of a web image. A link mapped to the identifier of the web image is read and distributed for presentation to a user.

### BACKGROUND

Internet search engines were developed to assist users in quickly and effectively finding information on the Internet. In recent years, the amount of information about people that is available on the Internet has grown, leading users to increasingly rely on search engines to locate such information. Frequently, however, search engines return many more results than a user is actually interested in viewing. In turn, the burden of uncovering relevant search results is sometimes placed on the user. For instance, users may be forced to scroll through many search results or repeatedly alter their search terms before finding a relevant web document.

There are multiple reasons for search engines failing to locate, or properly rank, search results related to a specific known person. One reason involves the breadth of some users' search queries. For instance, many users search for people using only common names. Because many people share common names, these search queries often return results that relate to incorrect people. Another reason is that search engines fail to accurately determine the relevance of search results. As a result, additional improvements are needed.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to systems, computerized methods, and computer media for resolving a search query for a person using an image of the person. Using the methods described herein, an image index containing web images and links to the web images is created. Identifiers of the web images are mapped to the links to the web images and stored in the image index. A search query for a person is received. Upon recognizing that the intent of the search query is to find information about the person, at least one digital image related to the person is selected, and an identifier of the digital image is submitted to the image index where it is compared against the identifiers of the stored web images. Based on the comparison, the identifier of the digital image is determined to correspond to an identifier of a web image. The original search query is resolved by reading a link mapped to the identifier of the web image that corresponds to the identifier of the digital image, and a representation of the link is distributed for presentation to a user within a set of search results.

### BRIEF DESCRIPTION OF THE DRAWINGS

Embodiments of the present invention are described in detail below with reference to the attached drawing figures, wherein:

FIG. 1 is a block diagram of an exemplary computing environment suitable for use in implementing embodiments of the present invention;

FIG. 2 is a graphical representation illustrating an exemplary system for resolving a search query for a person using an image of the person and distributing for presentation a link that is responsive to the search query within a set of search results, in accordance with embodiments of the present invention;

FIG. 3 is an illustrative screen display of an exemplary user interface for identifying and selecting a specific known person from a drop down menu, in accordance with embodiments of the present invention;

FIG. 4 is an illustrative screen display of an exemplary user interface for identifying and selecting a specific known person using a people disambiguation tool, in accordance with embodiments of the present invention;

FIG. 5 is an illustrative screen display of an exemplary user interface for identifying and selecting a specific known person from a social networking bar, in accordance with embodiments of the present invention;

FIG. 6 is a flow diagram showing an overall method for building an image index, in accordance with an embodiment of the present invention;

FIG. 7 is a flow diagram showing an overall method for retrieving a digital image of a person to resolve a search query for the person, in accordance with an embodiment of the present invention; and

FIG. 8 is a flow diagram showing an overall method for employing an image index to satisfy a search query for a person, in accordance with an embodiment of the present invention.

FIG. 9 is an illustrative screen display of an exemplary user interface for receiving a search query for a person, in accordance with an embodiment of the present invention.

FIG. 10 is an illustrative screen display of an exemplary user interface for receiving a search query for a person, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Embodiments of the present invention provide systems and computerized methods for resolving a search query for a person using an image of the person. An image index containing web images and links to the web images is created. Identifiers of the web images are mapped to the links to the web images and stored in the image index. A search query for a person is received. Upon recognizing that the intent of the search query is to find information about the person, a digital image related to or of the person is selected, and an identifier of the digital image is submitted to the image index where it is compared against the identifiers of the stored web images. Based on the comparison, the identifier of the digital image is determined to correspond to an identifier of a web image. The original search query is resolved by reading a link mapped to the identifier of the web image that corresponds to the identifier of the digital image, and a representation of the link is distributed for presentation to a user within a set of search results.

Accordingly, in one embodiment, an image index is built. A web-crawling mechanism that mines a plurality of online locations for web images and links to the web images is initiated. Identifiers of the web images are mapped to links to the web images, and the mapped identifiers and links are stored in the image index. If desired, the identifiers of the web images are mapped to a proper name of each person appearing in the web images and the mapped identifiers and the proper name are stored in the image index.

In another embodiment, a search query for a person is received. The intent of the search query to find information about the person is recognized. A digital image of the person is automatically selected. An identifier of the digital image is submitted to an image index, which stores mapped identifiers of web images and links to the web images. The search query is resolved by returning a link mapped to an identifier of a web image that corresponds with the identifier of the digital image. A representation of the link is presented for distribution within a set of search results that are responsive to the search query.

Embodiments of the present invention also provide computerized methods for employing the image index to satisfy a search query from a user. In one embodiment, the method includes accessing the image index to compare the identifier of the digital image against identifiers of the web images collected at the image index. In particular, the digital image is selected as a function of the content of the search query. Based on the comparison, a determination is made that the identifier of the digital image corresponds with one or more identifiers of the web images. Links mapped to the corresponding identifiers of the web images are read and distributed for presentation within a set of search results.

Having briefly described an overview of embodiments of the present invention, an exemplary operating environment suitable for implementing the present invention is described below.

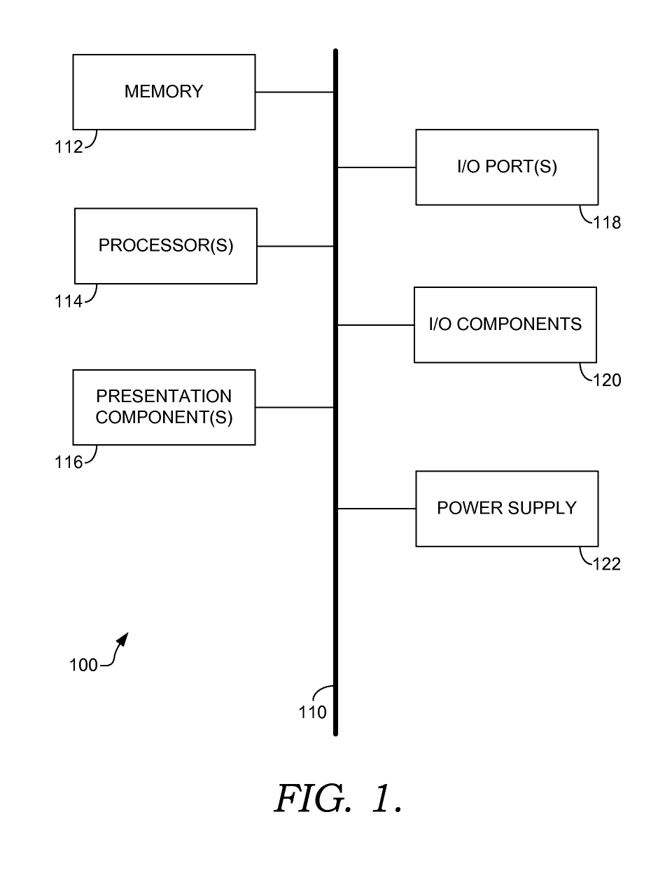

Referring to the drawings in general, and initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The invention may be practiced in a variety of system configurations, including hand-held devices, consumer electronics, general-purpose computers, specialty computing devices, etc. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.

Computing device 100 typically includes a variety of computer-readable media. Computer-readable media can be any available media that can be accessed by computing device 100 and includes both volatile and nonvolatile media, removable and nonremovable media. By way of example, and not limitation, computer-readable media may comprise computer storage media and communication media. Computer storage media include volatile and nonvolatile, removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information and which can be accessed by computing device 100. Communication media typically embody computer-readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disk drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

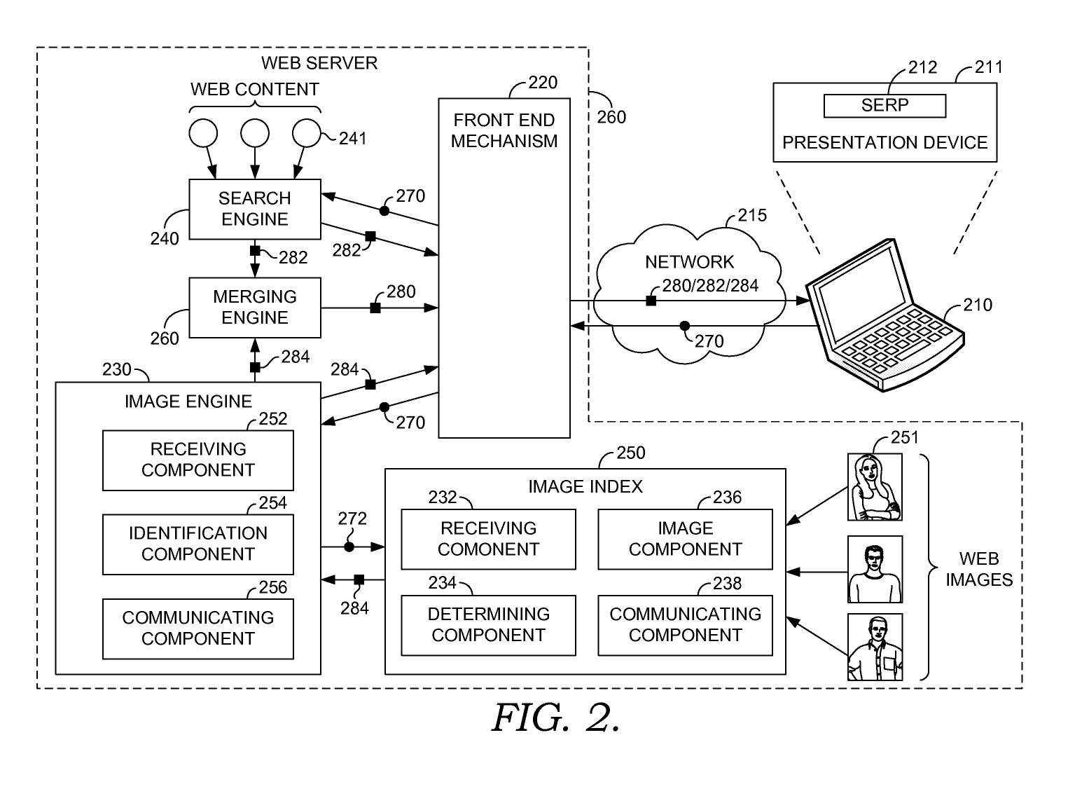

Turning now to FIG. 2, a graphical representation illustrating an exemplary system for resolving a search query for a person using an image of the person is provided. It will be understood and appreciated by those of ordinary skill in the act that the computing system 200 shown in FIG. 2 is merely an example of one suitable portion of an environment for resolving a search query for a person and is not intended to suggest any limitation as to the scope of the use or functionality of the present invention. Neither should the computing system architecture 200 be interpreted as having any dependency or requirement related to any single resource or combination of resources illustrated herein.

The system architecture for implementing the method of resolving a search query for a person using an image of the person will now be discussed with reference to FIG. 2. Initially, FIG. 2 is a block diagram illustrating a distributed computing environment 200 suitable for use in implementing embodiments of the present invention. The exemplary computing environment 200 includes a user device 210, a front end mechanism 220, an image engine 230, a search engine 240, an image index 250, a merging engine 260, and a network 215 that interconnects each of these items. Each of the user device 210 and the web server 260 shown in FIG. 2, may take the form of various types of computing devices, such as, for example, the computing device 100 described above with reference to FIG. 1. By way of example only and not limitation, the user device 310 and/or the web server 260 may be a personal computer, desktop computer, laptop computer, consumer electronic device, handheld device (e.g., personal digital assistant), various servers, processing equipment, and the like. It should be noted, however, that the invention is not limited to implementation on such computing devices but may be implemented on any of a variety of different types of computing devices within the scope of embodiments of the present invention.

Typically, the user device 210 includes, or is linked to, some form of computing unit (e.g., central processing unit, microprocessor, etc.) to support operations of the component(s) running thereon. As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the user device 210 to enable the device to perform communication-related processes and other operations. In another instance, the computing unit may encompass a processor (not shown) coupled to the computer-readable medium accommodated by the user device 210.

Generally, the computer-readable medium includes physical memory that stores, at least temporarily, a plurality of computer software components that are executable by the processor. As utilized herein, the term “processor” is not meant to be limiting and may encompass any elements of the computing unit that act in a computational capacity. In such capacity, the processor may be configured as a tangible article that processes instructions. In an exemplary embodiment, processing may involve fetching, decoding/interpreting, executing, and writing back instructions.

Also, beyond processing instructions, the processor may transfer information to and from other resources that are integral to, or disposed on, the user device 210. Generally, resources refer to software components or hardware mechanisms that enable the user device 210 or the web server 260 to perform a particular function. By way of example only, resource(s) accommodated by a server operate to assist the search engine 240 or the image engine 230 in receiving inputs from a user at the user device 210 and/or providing an appropriate communication in response to the inputs.

The user device 310 may include an input device (not shown) and a presentation device 211. Generally, the input device is provided to receive input(s) affecting, among other things, search results rendered by the image engine 230, the search engine 240, or the merging engine 260 and surfaced at a web browser on the presentation device 211. Illustrative input devices include a mouse, joystick, key pad, microphone, I/O components 120 of FIG. 1, or any other component capable of receiving a user input and communicating an indication of that input to the user device 210. By way of example only, the input device facilitates entry of a search query, which is communicated over the network 215 to the front end mechanism 220 for processing by the image engine 230 or the search engine 240.

In embodiments, the presentation device 211 is configured to render and/or present a search-engine results page (SERP) 212 thereon. The SERP 212 is configured to include a list of the search results 280, 282, 284 that the merging engine 260, the image engine 230, or the search engine 240, respectively return in response to the search query 270. Within the SERP 212, a list of links, titles, images, and/or a short description of the results that have been returned by the image engine 230, the search engine 240, and the merging engine 260 may appear.

The presentation device 211, which is operably coupled to an output of the user device 210, may be configured as any presentation component that is capable of presenting information to a user, such as a digital monitor, electronic display panel, touch-screen, analog set-top box, plasma screen, audio speakers, Braille pad, and the like. In one exemplary embodiment, the presentation device 211 is configured to present rich content, such as digital images and videos. In another exemplary embodiment, the presentation device 211 is capable of rendering other forms of media (i.e., audio signals).

This distributed computing environment 200 is but one example of a suitable environment that may be implemented to carry out aspects of the present invention and is not intended to suggest any limitation as to the scope of use or functionality of the invention. Neither should the illustrated distributed computing environment 200 be interpreted as having any dependency nor requirement relating to any one or combination of the devices 210 or 260, as illustrated. In other embodiments, one or more of the front end mechanism 220 and the image engine 230, the search engine 240, and the merging engine 260 and may be integrated directly into the web server 260, or on distributed nodes that interconnect to form the web server 260.

Accordingly, any number of components may be employed to achieve the desired functionality within the scope of embodiments of the present invention. Although the various components of FIG. 2 are shown with lines for the sake of clarity, in reality, delineating various components is not so clear, and, metaphorically, the lines would more accurately be grey or fuzzy. Further, although some components of FIG. 2 are depicted as single blocks, the depictions are exemplary in nature and in number and are not to be construed as limiting (e.g., although only one presentation device 211 is shown, many more may be communicatively coupled to the user device 210).

Further, the devices of the exemplary system architecture may be interconnected by any method known in the relevant field. For instance, the user device 210 and the web server 260 may be operably coupled via a distributed computing environment that includes multiple computing devices coupled with one another via one or more networks (e.g., network 215). In embodiments, the network may include, without limitation, one or more local area networks (LANs) and/or wide area networks (WANs). Such networking environments are commonplace in offices, enterprise-wide computer networks, intranets, and the Internet. Accordingly, the network is not further described herein.

Initially, the front end mechanism 220 is configured to receive a search query 270 issued by a user from the user device 210 and to receive a set of search results 280 from the image engine 230, the search engine 240, or the merging engine 260 that are generated, in part, based upon the search query 270. In this way, the front end mechanism 220 serves as, in part, an interface between the user device 210 and each of the image engine 230, the search engine 240, and the merging engine 260. In one aspect, the front end mechanism 220 may itself represent a separate search engine within the web server 260.

The search query 270 is distributed from the front end mechanism 220 to each of the image engine 230 and/or the search engine 240. In operation, the search engine 240 performs a search using the keywords and/or characters entered as the search query 270. The search engine 240 mines a plurality of web documents to find generic web content 241. The generic web content 241 is responsive to the user's search query 270, and typically relates to the person who the user is searching for (i.e., contains information about the user). The search engine 240 is also configured to communicate a representation of the search results list 282 to the merging engine 260, the front end mechanism 220, or both.

As shown in FIG. 2, the image engine 230 comprises a receiving component 222, a determining component 224, an image component 236, and a communicating component 238. The image engine 230 typically includes, or has access to, a variety of computer-readable material. In some embodiments, one or more of the components 232, 234, 236 and 238 may be implemented as stand-alone applications. In other embodiments, one or more of the components 232, 234, 236 and 238 may be integrated directly into the operating system of a computing device such as the remote computer 108 of FIG. 1. It will be understood that the components 232, 234, 236 and 238 illustrated in FIG. 2 are exemplary in nature and in number and should not be construed as limiting. Any number of components may be employed to achieve the desired functionality within the scope of embodiments hereof.

The receiving component 232 is configured to receive the search query 270. The search query 270 may contain keywords and/or combinations of characters that make up the content of the search query 270. The receiving component 232 is also configured to receive search results 282 from the image index 250. The search results 282 may contain headings, web images, URL addresses, short descriptions, and the like.

The determining component 234 utilizes the content of the search query 270 to determine the intent of the user in running the search. For instance, the determining component 234 is configured to determine that the intent of the user is to retrieve information about a specific known person. The determining component 234 makes such a determination based, in part, on the content of the search query 270. For example, if the search query 270 includes a person's proper name, common name, alias, or other identifying information (e.g., hometown, occupation, age, residency, familial information, birth date, etc.), the determining component 224 might initially determine that the user wants to search for a person. In another example, the determining component 234 is capable of recognizing that the intent of the user's search query 270 is directed to a person, as opposed to a place or item, based on factors that are external to the content of the search query 270. These external factors may include a previous user-initiated indication (e.g., selection of a control button on a toolbar) within a browser application that the user is conducting a search session that targets or is limited to people. The determining component 224 is also configured to utilize the content of the search query 270 to determine the identity of the specific known person for whom the user is searching.

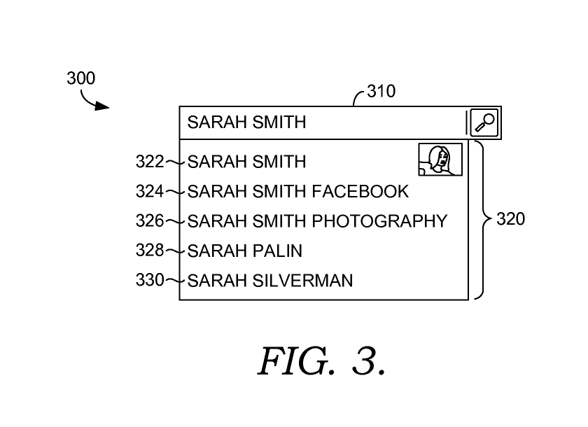

Turning to FIG. 3, an illustrative screen display of an exemplary user interface 300 for identifying and selecting a specific known person from a drop down menu 320 to initiate a search for the person is provided. In this example, a receiving component, such as the receiving component 232 of FIG. 2, receives information that the user is/has input search terms into the search query box 310. Upon receiving information about the user's input (e.g., “Sarah Smith”), a drop down menu 320, which suggests specific search terms, is presented to the user from the search query box 310. The drop down menu 320 can include any variety of information that might be relevant to the search query term(s) already entered in the search query box 310. For example, the information might contain a list of suggested names, images, and/or additional identifying information about a person, such as where the person lives, what the person does for a living, who the person is related to, or what hobbies the person has to assist the user in selecting additional or alternate search query terms. As such, the information presented within the drop down menu 320 shows the user that the image engine 230 of the FIG. 2 understands an intent of an ongoing search and enhances the quality of the searching experience by offering recommendations that are likely relevant to the user's searching intent.

The suggested information provided in the drop down menu 320 may also be selected based on a user profile. In one embodiment, the user profile might include a compilation of personal information that relates to the user. For example, the user profile may contain information that is stored in a password-protected personal account on a social media site, such as Twitter, Facebook, LinkedIn or MySpace. Exemplary information contained in a user profile might include text, videos, images, audio files, and the like.

As shown in FIG. 3, the user initially inputs a search query (e.g., “Sarah Smith”) into the search query box 310. Once the user inputs the search query terms, the drop down menu 320 suggests additional search query terms 322, 324, 326, 328, and 330. The user can select any one of the suggested search query terms 322, 324, 326, 328, or 330 based on the user's perception that one of the search query terms is the most relevant (e.g., search query term 322 which depicts a picture of the “Sarah Smith” about whom the user is searching for information). If the user selects a suggested entry from the drop down menu 320, a determining component, such as the determining component 234 of FIG. 2, uses the suggested search query term to identify with particularity the identity of the person for whom the user wishes to search.

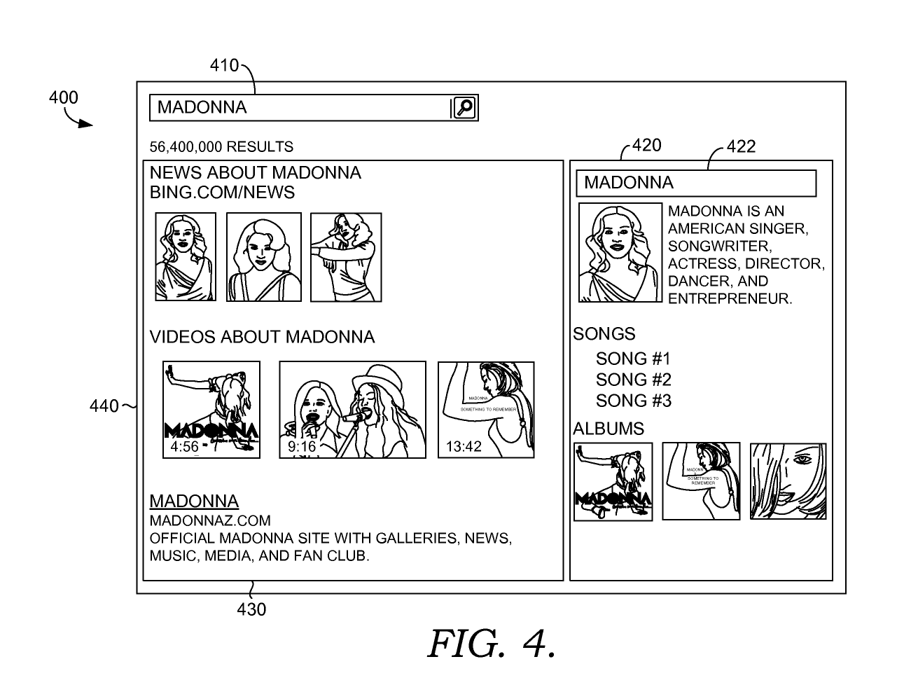

In another embodiment, a determining component, such as the determining component 234 of FIG. 2, can determine the identity of the searched-for person based on a user's selection of information about the person from a people disambiguation search result list 420. Turning to FIG. 4, an illustrative screen display of an exemplary user interface 400 for providing a people disambiguation search result list 420 is shown. The people disambiguation search result list 420 is a search result list that is presented separately from the generic search results list 430, but within the web page 440.

Once it is determined by the determining component that a select number of people are significantly represented (e.g., a search query 410 for “Madonna” retrieves only web documents related to the singer/-actress) in the search results list 430, the disambiguation search results list 420 may be created and presented to the user. In one embodiment, the disambiguation search results list parses the results for the significantly represented person and presents the results, typically, to the right of the generic search results list 430. While the people disambiguation search result list 420 is depicted as only one list in FIG. 4, it will be understood that it can include any number of lists for each significantly-represented person in the generic search results list 430.

If the user selects information from the people disambiguation search result list 420, the determining component utilizes the information to determine the identity of the person the user is searching for. For example, if in the people disambiguation search results list 420, the user selects the name “Madonna” from the heading 422, the determining component will determine that the user wants to find information about the famous singer/-actress.

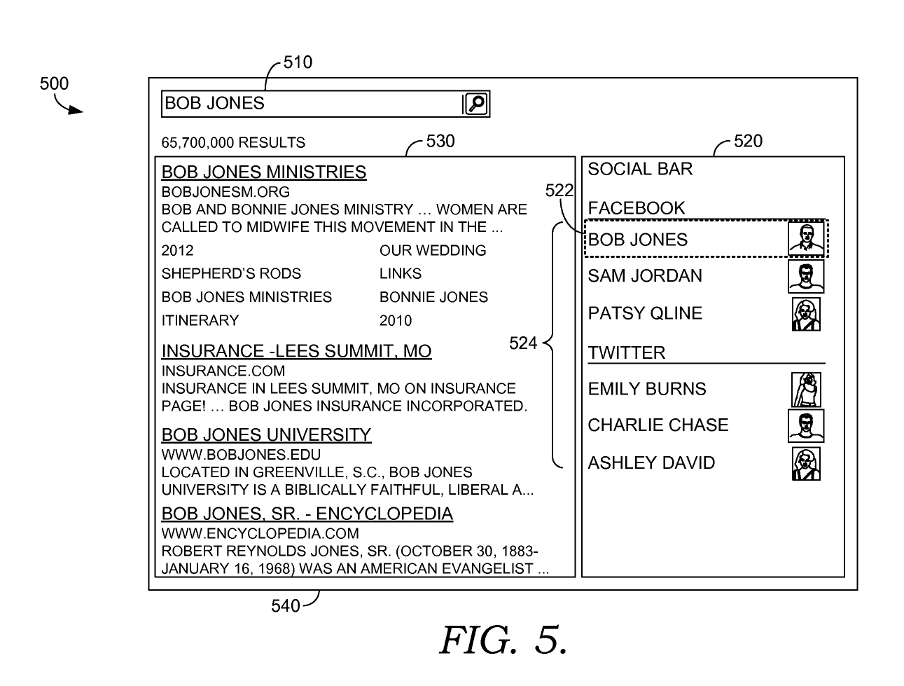

In still another embodiment, a determining component, such as the determining component 224 of FIG. 2, can identify the searched-for person based on the user's selection of a name and/or image of the person from a social bar, such as the social bar 520 of FIG. 5.

Turning to FIG. 5, an illustrative screen display of an exemplary user interface 500 for identifying and selecting a specific known person from a social bar is provided. The social bar 520 is separate from the search results list 530, which may be presented within the same web page 540 as the social bar 520. Within the social bar 520, there is a list of friends 524. The list of friends 524 may include user-selected names and/or images of people. The list of friends 524 may also include the names and/or images of people associated with the user through a social media site or user profile, such as Twitter, Facebook, LinkedIn or MySpace. Instead of inputting a search query (e.g., “Bob Jones”) into the search query box 510, the user may simply search for Bob Jones by selecting Bob Jones' name 522 from the social bar 520. The determining component will determine that the user wants to narrow his search to only information about his Facebook friend, Bob Jones.

The illustrative screen displays shown as FIGS. 3-5 are provided merely as examples and not by way of limitation. It will be understood that many other mechanisms exist for determining the identity of the specific known person. For example, a specific known person could be selected from a web page that is separate from the search engine web pages depicted in FIGS. 3-5 (e.g., a user could use an application, such as the Windows 8 Contacts List, to submit the name of the specific known person to the front end mechanism 220 of FIG. 2). The specific known person can also be identified by utilizing the content of the search query and/or factors external to the content of the search query, as described above.

Returning to FIG. 2, once the identity of the specific known person is determined by the determining component 234, an image component 236 of the image engine 230 searches for and retrieves a digital image of or relating to the specific known person. As referred to above with reference to FIGS. 3, 4, and 5, the digital image may be selected by the user from, for example, a drop down menu, a people disambiguation search results list or a social bar containing images and/or names of persons associated with the user. In one embodiment, the image component 236 may retrieve the digital image from any location on the Internet or a separate data store containing images of the person, such as the image index 250. For example, the image component 236 may select a digital image of the person from the user's account on a social networking website. In other embodiments, the image component 236 may retrieve a digital image that is related to or representative of the specific known person, but that does not contain an image of the person. For example, the image component 236 might retrieve a sunset image that is contained in both the person's Facebook account and the person's Twitter account because it relates to the person (i.e., the person's social media accounts). Further, while the digital image is described herein as a single image, it will be understood that the image component 236 may retrieve any number of digital images (e.g., every image contained of the specific known person contained in the specific known person's Facebook profile).

Once at least one digital image of the person is selected by the image component 236, the image component 236 utilizes an algorithm to create and assign an identifier to the digital image. One example of such an algorithm is the scale-invariant feature transform (SIFT), which is used in computer vision to detect and describe local features in images. For example, local features within the digital image may include a person's eyes and ears that are depicted in the image. The algorithm can identify those features (e.g., the eyes and ears) and describe them using an identifier. In this way, the identifier of the image can be compared against identifiers of other web images to determine whether the images are similar or dissimilar.

In one embodiment, pre-computed identifiers may be assigned to every digital image available on the Internet and stored in a data store (e.g., the image index 250) or cached for future use. If the image component 236 retrieves a digital image that has already been assigned a pre-computed identifier, the image component 236 is configured to automatically recognize and extract the pre-computed identifier.

In another embodiment, the image component 236 retrieves only an identifier of a digital image, and not the digital image itself. For example, digital images and/or pre-computed identifiers of the digital images may be stored in a data store (e.g., the image index 250). In addition, the digital images and pre-computed identifiers may be stored in association with information that identifies a particular person (e.g., the person's name or a unique ID). The image component 236 is thus configured to access the data store, locate the identifiers of digital images that are associated with the specific known person, and automatically recognize and extract the identifiers.

The communicating component 238 of the image engine 230 is configured to communicate the one or more identifiers of the digital images to the image index 250. The communicating component 238 is configured to also communicate the search results 284 back to the front end mechanism 220 for presentation to the user.

As shown in FIG. 2, the image index 250 comprises a receiving component 252, an identification component 254, and a communicating component 256. The image index 250 typically includes, or has access to, a variety of computer-readable material. In some embodiments, one or more of the components 252, 254, and 256 may be implemented as stand-alone applications. In other embodiments, one or more of the components 252, 254, and 256 may be integrated directly into the operating system of a computing device such as the remote computer 108 of FIG. 1. It will be understood that the components 252, 254, and 256 illustrated in FIG. 2 are exemplary in nature and in number and should not be construed as limiting. Any number of components may be employed to achieve the desired functionality within the scope of embodiments hereof.

The image index 250 is configured to store mapped identifiers of web images 251 (i.e., images available on the web) and links to the web images 251. Web crawlers first locate the web images 251 and corresponding links to the web images 251. The web crawlers may also retrieve the names of persons associated with or depicted in the web images 251. Further, the web-crawling process may occur automatically and/or continuously.

The receiving component 252 of the image index 250 receives the web images 251 and the links to the web images 251. In one embodiment, the links to the web images 251 are uniform resource locators (URLs) used to locate web pages that include the web images 251. In another embodiment, the links to the web images 251 include search instructions for locating the web pages that contain the web images 251. As used herein, the term “links” is not meant to be construed as being limited to simply web addresses. Further, although various different embodiments of links have been described, it should be understood and appreciated that other types of suitable hypertext or reference to a web site may be used, and that embodiments of the present invention are not limited to the specific examples described herein. For instance, embodiments of the present invention contemplate employing an object (e.g., image or other content) that, when selected by a user navigates the user to a profile of a social media site that hosts the object.

The identification component 254 is configured to generate and assign an identifier to every web image received at the receiving component 252 of the image index 250. The identifier is intended to detect and describe local features in the web images 251. Each web image, therefore, is assigned an identifier based on the unique features of the web image, such as the color, contrast, or hue of the web image or objects located therein. Similar to the identifier of the digital image described above, the identifiers of the web images 251 are generated according to an algorithm, such as the SIFT algorithm. It will be understood, however, that the SIFT algorithm is provided only as an example of one possible algorithm and not by way of limitation.

The identification component 254 maps the identifiers of the web images to links associated with the web images. Each mapping of the identifiers and the links to the web images is stored in the image index 250. In addition, the names of persons appearing in or depicted by the web images may also be mapped to the identifiers and/or links of the web images and stored in the image index 250. Other information accessible by the web crawlers and used to identify the origination of the web image, the contents of the web image, or objects and/or persons depicted in the web images may also be mapped to the identifiers of the web images 251 and stored in the image index 250.

The identification component 254 is also configured to process the content of the search query 272 (i.e., the identifier of the digital image) by comparing the one or more identifiers of the one or more digital images against the identifiers of the web images 251 stored in the image index 250. The identification component 254 then determines, based upon the comparison, whether the identifier of a digital image is substantially similar to or the same as the identifier for each of the web images 251. If a digital image and a web image have similar identifiers, they are determined to correspond to each other. It is likely that the corresponding images contain similar features or include an image of the person who formed the basis for the original search query 270. The association between each digital image and corresponding web images 251 may be stored in the image index 250.

The identification component 254 reads a link from every web image that corresponds to the identifier of the digital image identifier. The communicating component 256 of the image index 250 communicates the link(s), a representation of the link(s), or other mapped content associated with each corresponding web image to the image engine 250. A representation of a link might include, for instance, a web image, a URL address, a short description, or a view of the web page containing the web image. The communicating component 256 is configured to communicate the search results 284 to the merging engine 260 or to the receiving component 222 of the front end mechanism 220.

The merging engine 260 is configured to receive the search results lists 282 and 284 from each of the image engine 230 and the search engine 240, respectively. At the merging engine 260, the search results 280 and the search results 282 are merged together to create one search results list 284. The merged search results list 280 is thus a compilation of the search results lists 282 and 284. The merging engine 260 is also configured to rank the search results 282 and 284 based on their relevance. Relevance may be determined according to an algorithm. As an example used for illustrative purposes only, results returned from the image engine 230 may be ranked higher, as being more relevant than results from the search engine 240 (i.e., the results returned from the image engine 230 include links to web documents known to contain an image of, and, likely, other information about, the person whose name was entered as the search query 270). Once merged, the communicating component 256 of the merging engine 260 distributes the merged search results list 280 to the front end mechanism 220 for distribution to the user.

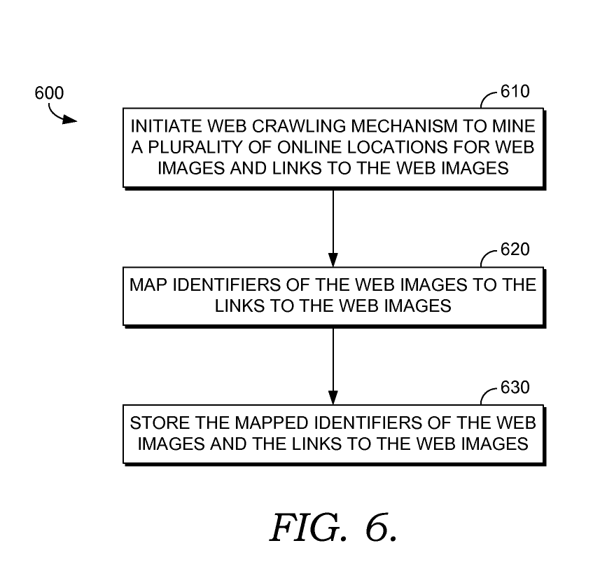

Turning now to FIG. 6, a flow diagram is shown depicting an illustrative method 600 for building an image index, in accordance with embodiments of the invention. Initially, it should be appreciated and understood that although the terms “step” and/or “block” may be used herein to connote different elements of methods employed, the terms should not be interpreted as implying any particular order among or between various steps herein disclosed unless and except when the order of individual steps is explicitly described.

In an exemplary embodiment, the method 600 involves building an image index. At a step 310, a web-crawling mechanism is initiated for mining a plurality of online locations for web images and links to the web images. As more fully discussed above, the web-crawling mechanism may also mine web images or associated web documents for other information about people appearing in the web images, such as the names of the people. At a step 312, identifiers of the web images are mapped to the links to the web images. Finally, at a step 314, the mapped identifiers of the web images and the links to the web images are stored in the image index. Although not depicted, other identifying information associated with the web images or the web documents originally containing the web images may also be mapped to identifiers of the web images and stored in the image index.

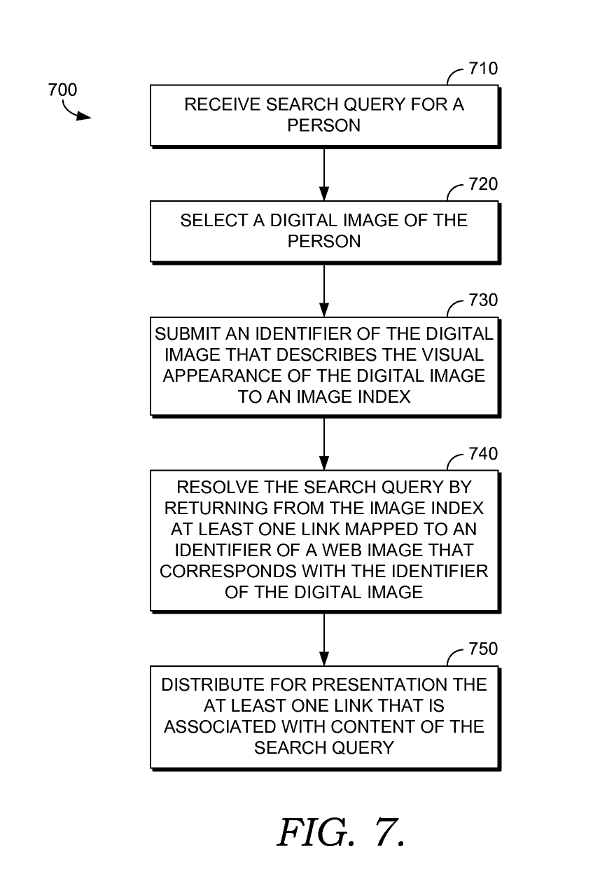

Referring to FIG. 7, a flow diagram is shown depicting an illustrative method 700 for retrieving a digital image of a person to resolve a search query for the person, in accordance with an embodiment of the present invention. Initially, the method 700 may involve, at a step 710, receiving a search query for a person.

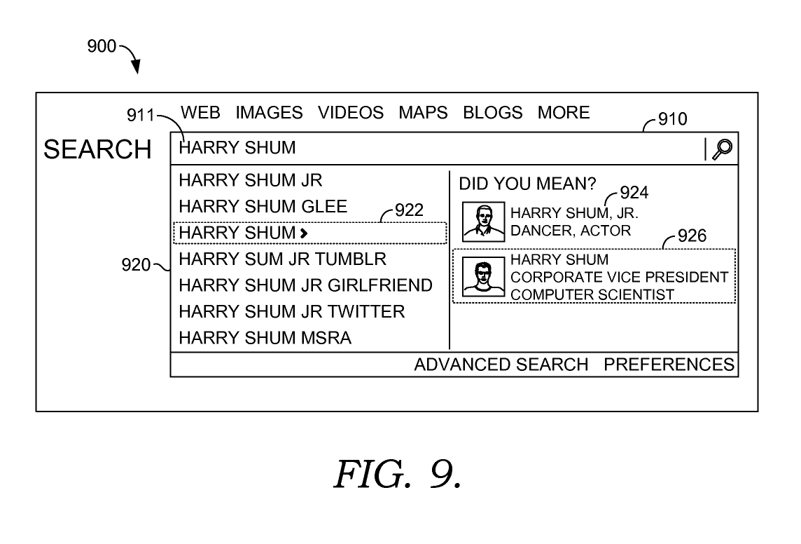

As shown in FIG. 9, an illustrative screen display of an exemplary user interface 900 for receiving a search query for a person is depicted, in accordance with an embodiment of the present invention. At a search query box 910, a user inputs a search query 911 that may include the name (e.g., “Harry Shum”) or other identifying information for a person. In turn, the user may receive feedback from the search engine that includes additional suggestions for narrowing the search query 911. For example, if the user passes a browser over the name 922 from the drop down menu 920, the user can choose from two selected persons, person 924 and person 926, to narrow his search. Thus, a search query can include the original search query 911 and any additional user selections (e.g., the person 924) to narrow and/or broaden his search.

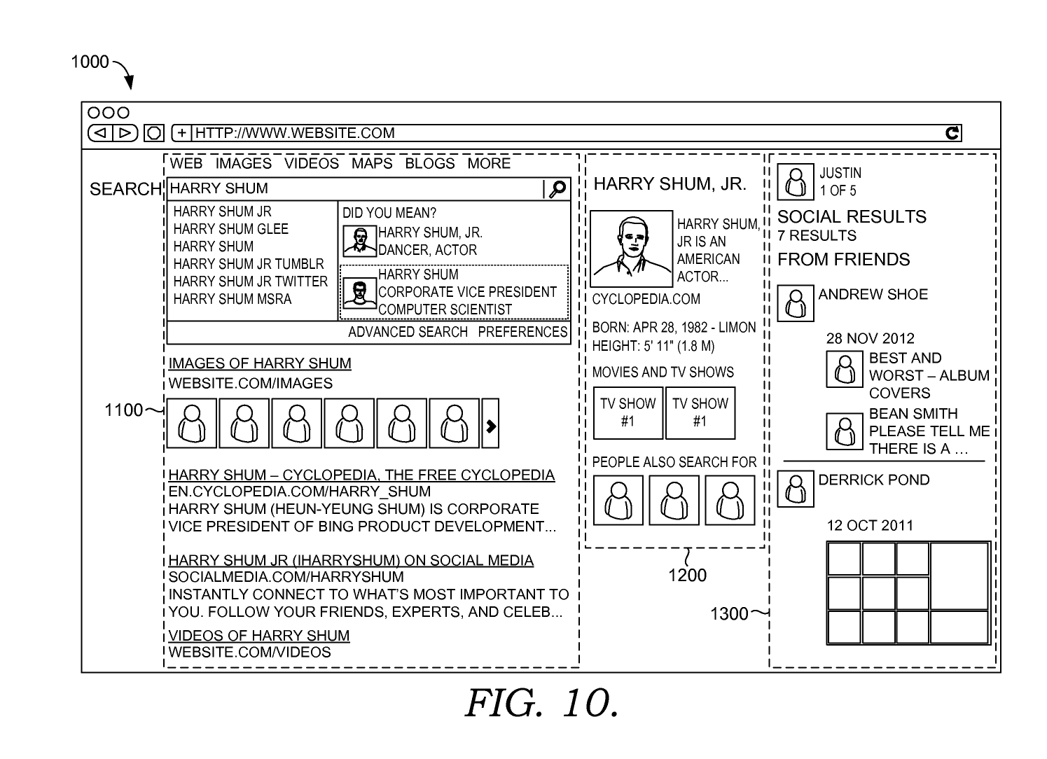

Similarly, as shown in FIG. 10 an illustrative screen display of an exemplary user interface 1000 for receiving a search query for a person is depicted, in accordance with an embodiment of the present invention. FIG. 10 provides a more expansive illustration of the ways in which a user might search for or select a person for whom the user wishes to find more information. For example, a user may search for a specific person by selecting links or icons from the generic search engine 1110, the person disambiguation search result list 1200, or the social bar 1300, which are respectively similar to the examples provided above in FIGS. 3-5. Selecting links or icons from each of these search results can help to narrow the search results returned to the user. For example, if the user selects the name “Harry Shum, Jr.” from the person disambiguation search result list 1200, the search query will be more narrowly directed to finding information about the American actor.

Referring again to FIG. 7, at a step 720, the intent of trying to find information about a person based on entering a search query for the person is recognized. Upon recognizing the intent of the search query, a digital image of the person is selected at a step 730. As indicated at a step 740, an identifier of the digital image of the person is submitted to the image index, and the search query is subsequently resolved. The search query is resolved by returning from the image index at least one link that is mapped to an identifier of a web image that corresponds to an identifier of the digital image. Additionally, the search query may be resolved when the identifier of the web image is mapped to at least one name of a person that appears in the web image, and the name of the person corresponds with the name that is entered as the content of the search query. Finally, at a step 760, the at least one link is distributed for presentation within a set of search results that are responsive to the search query and that are ranked according to their relevance. Search results that are responsive to the search query may include results that mention or relate to the person who was named in the user's search query.

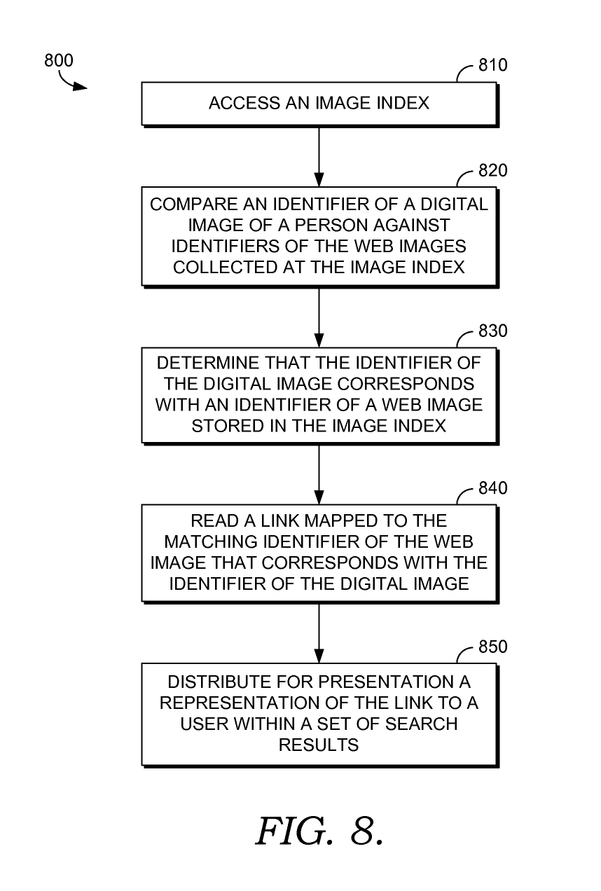

Referring to FIG. 8, a flow diagram is shown depicting illustrative method 800 for employing an image index to satisfy a search query for a person, in accordance with an embodiment of the present invention. Initially, the method 800 may represent a computerized method carried out by one or more of an image engine, a search engine, and a merging engine (running on a processor). In embodiments, the method 800 may involve the step 810 of accessing an image index. At a step 820, the identifier of a digital image is compared against identifiers of the web images collected at the image index. In particular, the digital image may be selected as a function of the content of the search query. The content of the search query will, in many embodiments, include the name of the person for whom the user would like to search. Based on the comparison, at a step 830, the identifier of the digital image is determined to correspond to an identifier of a web image, and, at a step 840, at least one link mapped to the corresponding identifier of the web image is read. At a step 850, a representation of the link is distributed for presentation to a user within a set of search results. Although not shown, the set of search results may include results not obtained from the image engine. In other words, search results retrieved by a generic search engine may be merged with the link. The link and the search results obtained from the generic search engine may, in some embodiments, be ranked according to an algorithm.

If desired, the results that are distributed for presentation to the user may include a representation of the link and separate search results obtained from the generic search engine. Additionally, adjacent to, side-by-side, or near to each representation of the links, a web image associated with the link and/or the content of the link may also be presented so as to indicate to the user the reason for returning the link within the set of search results.

Various embodiments of the invention have been described to be illustrative rather than restrictive. Alternate embodiments will become apparent from time to time without departing from the scope of embodiments of the inventions. It will be understood that certain features and sub-combinations are of utility and may be employed without reference to other features and sub-combinations. This is contemplated by and is within the scope of the claims.

1. One or more computer storage media having computer-executable instructions embodied thereon that, when executed, perform a method of building an image index, the method comprising:
initiating a web-crawling mechanism to mine a plurality of online locations for web images and links to the web images;
mapping identifiers of the web images to links to the web images; and
storing the mapped identifiers of the web images and the links to the web images in the image index.

2. The media of claim 1, wherein the method further comprises:
mapping the identifiers of the web images to a proper name of one or more persons that appear in the web images; and
storing the mapped identifiers of the web images and the proper name.

3. The media of claim 1, wherein the identifiers describe a visual appearance of the web images.

4. The media of claim 1, wherein the web images depict one or more persons.

5. The media of claim 1, wherein the links to the web images comprise uniform resource locator (URL) addresses to web pages that contain the web images.

6. One or more computer storage media having computer-executable instructions embodied thereon that, when executed, perform a method of retrieving at least one digital image related to a person, the method comprising:
receiving a search query for the person;
recognizing an intent of the search query is to find information on the person;
automatically selecting at least one digital image related to the person using content of the search query;
submitting an identifier of the at least one digital image to an image index, wherein the image index comprises a mapping between identifiers of web images and links to the web images;
resolving the search query by returning at least one link mapped to an identifier of a web image, wherein the identifier of the at least one digital image corresponds with the identifier of the web image within the mapping of the image index; and
distributing for presentation a representation of the at least one link within a set of search results that are responsive to the search query.

7. The media of claim 6, wherein the content of the search query includes at least the proper name of the person.

8. The media of claim 6, wherein the digital image is selected from a social networking web site.

9. The media of claim 6, wherein the digital image is selected from a user profile, and wherein the user profile includes personal information or digital images stored in association with one or more social networking websites.

10. The media of claim 6, wherein the at least one link comprises a uniform resource locator (URL) address to a web page that contains the web image.

11. The media of claim 6, wherein the image index represents at least a mapping between identifiers of the web images and one or more proper names of persons that appear in the web images.

12. The media of claim 11, wherein resolving the search query further includes returning from the image index at least one link mapped to an identifier of the web image, wherein the identifier of the web image is mapped to one or more proper names of persons that appear in the web image, and wherein the mapped one or more proper names correspond with a proper name entered as the content of the search query for the person.

13. A computerized method for employing an image index to satisfy a search query from a user, the method comprising:
accessing the image index, wherein the image index comprises a mapping between identifiers of web images and links to the web images;
comparing an identifier of a digital image against identifiers of the web images collected at the image index, wherein the digital image is selected as a function of content of the search query;
based on the comparison, determining that the identifier of the digital image corresponds with one or more identifiers of the web images;
reading one or more links mapped to the one or more corresponding identifiers of the web images; and
distributing for presentation a representation of the one or more links to the user within a set of search results that are responsive to the search query.

14. The method of claim 13, further comprising storing within the image index an association between the identifier of the digital image and the one or more identifiers of the web images.

15. The method of claim 13, further comprising distributing for presentation a representation of the web images to a user within the set of search results.

16. The method of claim 15, wherein the set of search results includes the representation of the web images presented in a side-by-side view to the representation of the one or more links.

17. The method of claim 13, wherein the identifier of the digital image is determined to correspond to the one or more identifiers of the web images based on, in part, being substantially similar to the one or more identifiers of the web images.

18. The method of claim 13, wherein the method further comprises providing an image engine for distributing for presentation the one or more links to a user within the set of search results.

19. The method of claim 18, further comprising:
merging the one or more links distributed for presentation by the image engine with links retrieved by a search engine; and
ranking the one or more links distributed for presentation by the image engine and the links retrieved by the search engine within the set of search results.

20. The method of claim 19, wherein the one or more links distributed for presentation by the image engine and the links retrieved by the search engine are ranked according to relevance to the search query.
